(19) United States
(12) Patent Application Publication
(10) Pub. No.: US 2013/0166852 A1
(43) Pub. Date: Jun. 27, 2013

(54) METHOD FOR HIBERNATION MECHANISM AND COMPUTER SYSTEM THEREFOR

(71) Applicants: Shi-Wu Lo, Changhua City (TW); Shau-Yin Tseng, Emei Township (TW)

(72) Inventors: Shi-Wu Lo, Changhua City (TW); Shau-Yin Tseng, Emei Township (TW)

(73) Assignee: INDUSTRIAL TECHNOLOGY RESEARCH INSTITUTE, HSINCHU (TW)

(21) Appl. No.: 13/470,604

(22) Filed: May 14, 2012

(30) Foreign Application Priority Data
Dec. 21, 2011 (TW) 100147798

(51) Int. Cl. G06F 12/00

(52) U.S. Cl. 711/154; 711/E12.001

(57) ABSTRACT

A method for hibernation mechanism and a computer system therefor are provided. The method includes the followings. An initial process of a hibernation mechanism is performed in a computer system, in which a non-swappable memory of a main memory is partitioned into a plurality of non-swappable segments, and each segment corresponds to a status value indicating whether the content of the segment has been changed. During a process of entering a hibernation state, for each non-swappable segment, it is determined whether the segment is to be written to a storage device according to the status value. The segment is written into the storage device when a determination result indicates the segment has been changed, or else the computer does not write the segment to the storage device when the determination result indicates the segment is has not been changed.

This application claims the benefit of Taiwan application Serial No. 100147798, filed Dec. 21, 2011, the disclosure of which is incorporated by reference herein in its entirety.

### BACKGROUND

1. Technical Field

The disclosed embodiments relate in general to a method for a hibernation mechanism and a computer system therefor.

2. Description of the Related Art

As the code for an Android operating system made public by Google is extremely suitable in an embedded system, the number of products including mobile phones, tablet computers, smart television and automobile computers implementing an Android operating system is quickly expanding. During the development of the products, differentiations can be achieved through not only hardware designs but also Android software designs.

A fast boot process renders even more easily accessible digital information as already is, and thus practically offers readily available digital household appliances immediately after powering on. In most smart devices, a shut-down button is set as a standby mode instead of a real power-off mode. Although the standby mode effectively reduces a wait time, such design is regarded as a “high power consumption fast boot” as it nevertheless continuously consumes electric power. The electric power consumed by the standby mode increases global carbon dioxide emissions by 1%. According to European Union regulations, the power consumption of smart household appliances must be less than 0.1 W when not in use. Therefore, there is a need for a high-speed boot method for mitigating issues brought by the standby mode as well as for meeting the above requirement. Currently, some high-speed boot methods are performed based on a sleep mode.

Further, most current embedded systems including for example digital cameras, navigation systems, smart mobile phones and tablet computers adopt a flash memory as a storage device. However, the flash memory has a limitation on the number of write processes, which yet needs to be overcome.

### SUMMARY

The disclosure is directed to a method for a hibernation mechanism and a computer system therefor.

According to one embodiment, a method for a hibernation mechanism is provided. The method is applicable to a computer system and includes the followings. An initial process of a hibernation mechanism is first performed in the computer system. In the computer system, at least one non-swappable memory of a main memory is partitioned into a plurality of non-swappable segments, and each of the non-swappable segments corresponds to a status value indicating whether content of the non-swappable segment has been changed. During a process of entering a hibernation state, for each of the non-swappable segments, it is determined whether the non-swappable segment is to be written to at least one storage device according to the status value of the non-swappable segment. When a determination result indicates the content of the non-swappable segment has been changed, the non-swappable segment is written to the at least storage device of the computer system. When the determination result indicates the content of the non-swappable segment has not been changed, the computer system does not write the non-swappable segment to the at least one storage device of the computer system in the hibernation state.

According to another embodiment, a computer system is provided. The computer system includes at least one main memory, at least one storage device, and at least one processing unit coupled to the at least one processing unit and the at least one storage device. The at least one processing unit performs an initial process of a hibernation mechanism. A non-swappable memory of the at least one main memory is partitioned into a plurality of non-swappable segments, and each of the non-swappable segments corresponds to a status value indicating whether content of the non-swappable segment has been changed. During a process of the computer system entering a hibernation state, for each of the non-swappable segments, the at least one processing unit determines whether to write the non-swappable segment to the at least one storage device according to the status value. When a determination result indicates the content of the non-swappable segment has been changed, the at least processing module writes the non-swappable segment to the at least one storage device. When the determination result indicates the content of the non-swappable segment has not been changed, the at least one processing unit does not write the non-swappable unit to the at least storage device in the hibernation state.

### BRIEF DESCRIPTION OF THE DRAWINGS

FIG. 1 is a block diagram of a computer system according to one embodiment.

FIG. 2 is a flowchart of a method for a hibernation mechanism according to one embodiment.

FIG. 3 is a schematic diagram of a relationship between a main memory and a secondary memory.

FIG. 4 is a flowchart of the method in FIG. 2 according to one embodiment.

FIG. 5 is a block diagram of implementing the embodiment in FIG. 4 to a computer system according to one embodiment.

FIG. 6 is a flowchart of the method in FIG. 2 according to another embodiment.

FIG. 7 is a flowchart of the method in FIG. 6 according to another embodiment.

FIG. 8 is a block diagram of implementing the embodiment in FIG. 6 to a computer system according to one embodiment.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

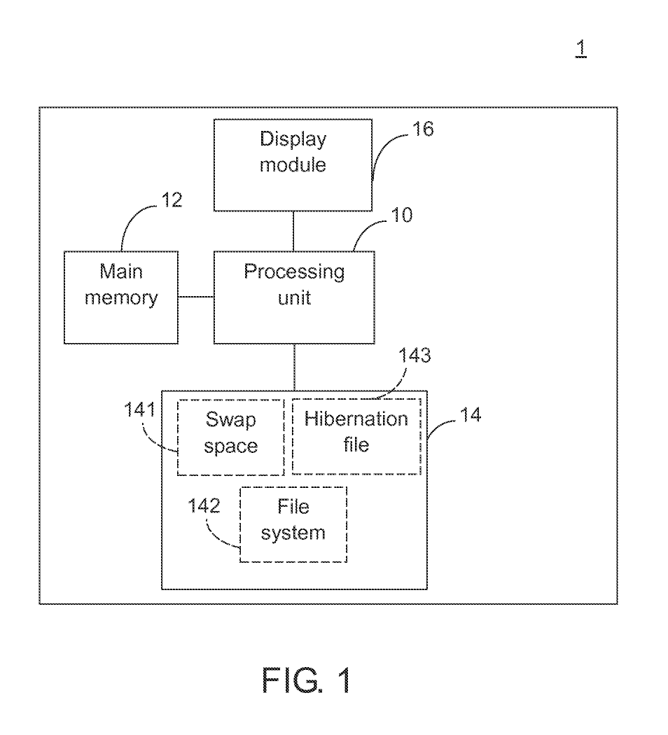

An embodiment of a method for a hibernation mechanism and a computer system therefor shall be described below. FIG. 1 shows a block diagram of a computer system according to one embodiment. Referring to FIG. 1, a computer system 1 includes a processing unit 10, a main memory 12 and a storage device 14. For example, the processing unit 10 is a single-core or multi-core processor, the computer system 1 is a single-chip system, and the main memory 12 is a volatile memory such as a RAM or an SDRAM. The storage device 14 serves as a secondary memory of the computer system 1. For example, the storage device 14 is a non-volatile memory such as a flash memory for storing a swap space 141, a file system 142 and a hibernation file 143 of the computer system 1. Based on the diagram of the computer system 1 in FIG. 1, various personal computers or embedded systems, e.g., portable devices, and multimedia, communication or network devices, may be realized according to different applications. For example, the computer system 1 may be implemented in cooperation with a display module 16 such as a touch screen or other associated hardware modules to form a smart mobile phone, an Internet device or a tablet computer.

The main memory, the storage device and the processing units in the diagram and description of the embodiment are depicted in a block diagram. However, it should be noted that the number of the main memory, the storage device and the processing units in this embodiment is not limited to one although one of each is depicted. For example, the computer system may also include several processing units such as a multi-core processor or multiple processors, and the main memory (or the secondary memory) may be consisted of several relative memory devices.

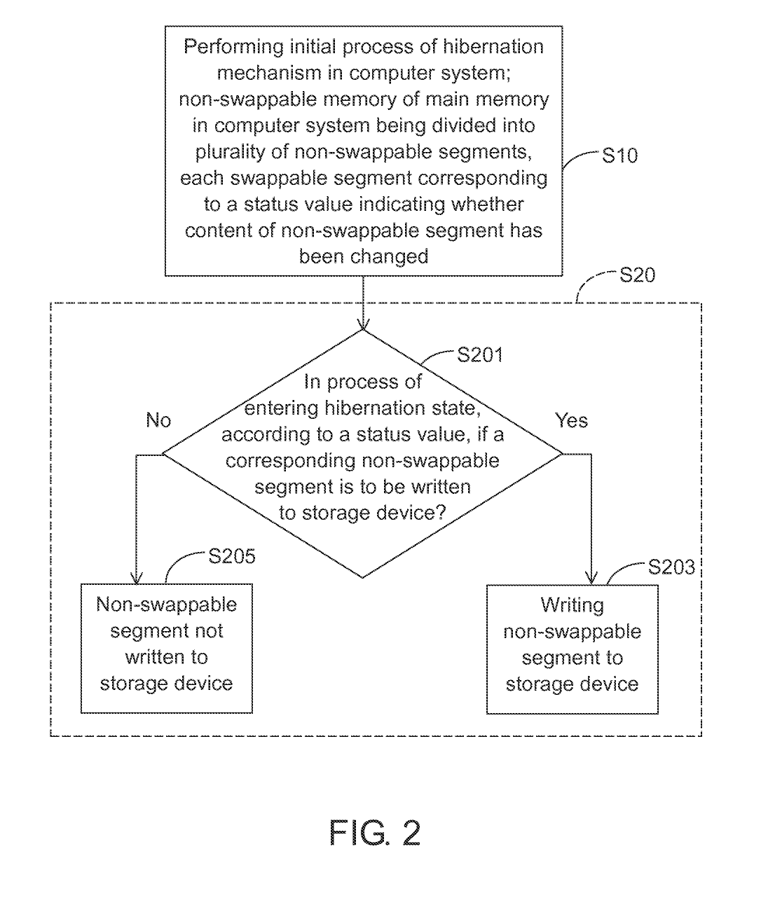

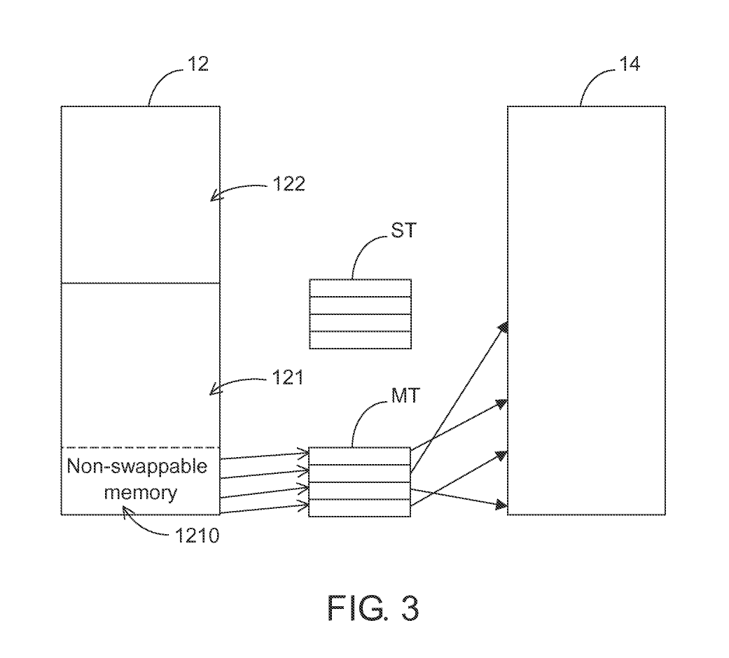

FIG. 2 shows a flowchart of a method for a hibernation mechanism according to one embodiment. FIG. 3 shows a schematic diagram of a relationship between the main memory and the secondary memory. The method is capable of reducing a write process from the main memory 12 to the storage memory 14 as the computer system 1 in FIG. 1 enters a hibernation state, and more particularly, the method is capable of reducing a data amount written from a non-swappable memory 1210 in the main memory 12 to the storage device 14.

Referring to FIGS. 1, 2, and 3, the method in FIG. 2 is applicable to the computer system 1 shown in FIG. 1. In step S10 in FIG. 2, an initial process of a hibernation mechanism is performed in the computer system 1. The non-swappable memory 1210 of the main memory 12 in the computer system 1 is partitioned into a plurality of non-swappable segments such as two, four or multiple segments. Each of the swappable segments corresponds to a status value indicating whether content of the non-swappable segment has been changed. Referring to FIG. 3, different regions in the main memory 12 are divided into two types—a first type is a swappable memory and a second type is a non-swappable memory. For example, the non-swappable memory includes an operating system kernel executed by the computer system 1, an application system and hardware-associated status information. Under normal operations, the operating system is unlikely to be located or set to a memory region other than the non-swappable memory. In step S10, to fulfill requirements for entering a hibernation state, the initial process further partitions the non-swappable memory 1210 into a plurality of segments, and respectively designates a corresponding status value to the segments. The status values are collectively regarded as a status table ST of the non-swappable segments. The segments may be of the same size or of different size.

Step S20 is performed after the initial process in step S10. As shown in step S20, during a process of the computer system 1 entering a hibernation state of the hibernation mechanism, it is determined whether each of the non-swappable segments is to be written to the storage device 14. More specifically, in step S201, according to the status value of the non-swappable segment, it is determined whether the non-swappable segment is to be written to the storage device 14. When a determination result in step S201 indicates that content of the non-swappable segment has been changed, step S203 is performed to write the non-swappable segment to the storage device 14 of the computer system 14. For example, the non-swappable segment is written to a swap space 141, a file system 142 or a hibernation file 143. When the determination result in step S201 indicates the content of the non-swappable segment has not been changed, the computer system 1 does not write the non-swappable segment to the storage device 14 in the hibernation state, as shown in block S205.

In a conventional hibernation mechanism, the non-swappable memory 1210 is entirely written to a non-volatile memory each time the computer system 1 enters a hibernation state. In contrast, in the initial process of the hibernation mechanism in this embodiment, the non-swappable memory is further partitioned into a plurality of segments each corresponding to a status value, and only non-swappable segments having changed content are written to the storage device when entering the hibernation state.

Further, during the process of entering the hibernation state when performing step S20, a table (e.g., a table MT in FIG. 3) may be established to describe memory positions of the segments of the non-swappable memory 1210 in the storage device 14. When implementing the hibernation mechanism, the table MT may describe how the non-swappable memory 1210 may be reconstructed from the swap space 141, the file system 142 or the hibernation file 143.

In one embodiment, after resuming from the hibernation state in step S20, in the event that the computer system 1 again enters the hibernation state, step S20 may be performed until the computer system 1 reboots (e.g., a cold boot or a warm boot), or the method may again be performed from step S10. In other embodiments, the method for fast boot based on the hibernation mechanism may also be achieved through the method in FIG. 2.

Other embodiments based on the method in FIG. 2 shall be described below.

### First Embodiment

In this embodiment, operations details of a computer system are illustrated by taking Linux or an operating system based on Linux as an example. For example, the operating system is a software pack such as TuxOnIce and sususp for implementing software suspend in Linux. TuxOnIce, being a descendent of swsusp, is an enhanced generation of swsusp and has a faster hibernation and response time. In this embodiment, a TuxOnIce operating platform based on Linux is taken as an example.

Before explaining the embodiment of implementing the method in FIG. 2 to a TuxOnIce operating platform, an approach including two steps for generating an image file to be written to the storage device (e.g., a non-volatile memory or a hard disk) by TuxOnIce shall be first described. Referring to FIG. 3, TuxOnIce divides the main memory 12 into two parts—a first-part memory 121 and a second-part memory 122. In the first step, the second-part memory 122 in FIG. 3 is written to the secondary memory, e.g., the storage device 14. In the second step, the first-part memory 121 is written to the second memory.

A main purpose of the first step is to offer the system with sufficient free space for the second step, such that sufficient working memory is available in the second step for ensuring that the second step is a one-time write (i.e., an atomic write).

Assuming majority of the main memory in the system is the non-swappable memory, it is much likely that TuxOnIce fails to write sufficient memory to the secondary memory in the first step, thus resulting in insufficient working memory in the second step. In the event of the above occurrence, TuxOnIce reports the error to a user to inform the user of the failure of entering a sleep mode. However, such situation shall not be discussed further.

Under most circumstances, majority of the memory in the system is the first-part memory, which includes a considerable amount as the non-swappable memory. As such, TuxOnIce fabricates the first-part memory into a single image file, which is to be one-time written to become a hibernation file. The hibernation file can be stored in the file system or in the swap space. Alternatively, the hibernation file may even be stored to a physical device other than the system, e.g., a network storage such as a cloud storage device.

When applying suspend to disk or hibernation of TuxOnIce to the storage device 14 (e.g., a flash memory device), the second-part swappable memory is written out by page-out via a virtual memory, and repeated data (a same duplicate in the secondary memory) is not practically written out. However, since the first-part memory is one-time written out based on TuxOnIce, an actual write out is required for repeated data in the first-part memory.

The first embodiment is targeted at reducing the write out process from the first-part memory to the secondary memory. Therefore, in step S10 in FIG. 2, a memory management unit (MMU) in the computer system is utilized to detect whether each of the non-swappable segments has been modified to accordingly record status values corresponding to the non-swappable segments. For example, a dirty bit in the MMU is utilized as basis for the above judgment. A feature according to the first embodiment is that, the hibernation mechanism for TuxOnIce is adjusted in a way that a non-swappable segment is not written out to the secondary memory if the non-swappable segment has not been modified.

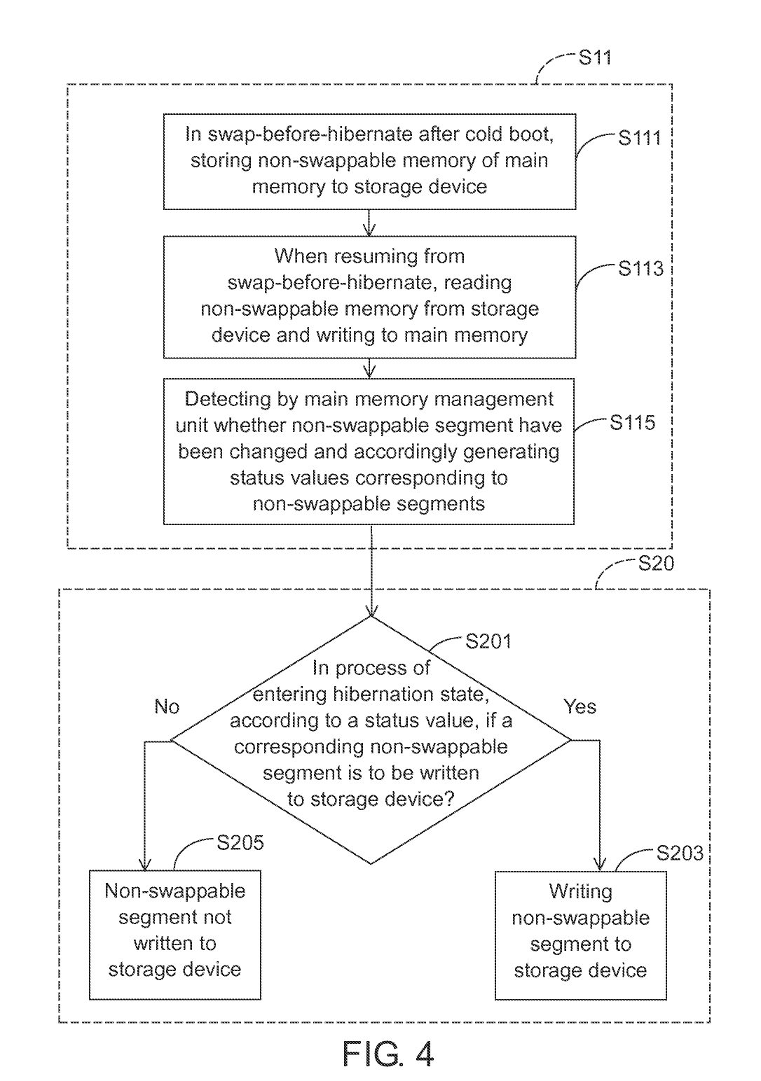

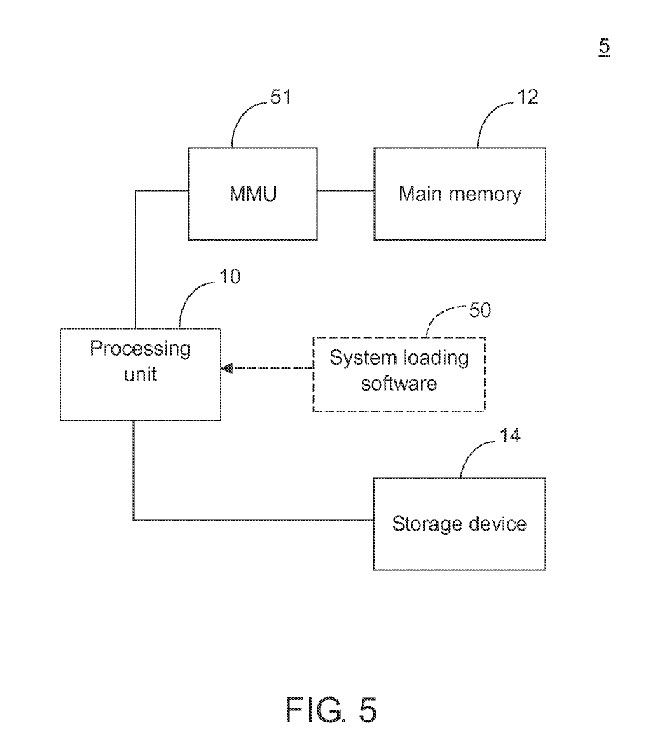

FIG. 4 shows a detailed flowchart of step S10 and step S20 in FIG. 2 according to an embodiment. FIG. 5 shows a block diagram of the embodiment in FIG. 4 applied to a computer system according to one embodiment. Referring to FIG. 4, step S11, as an initial process before step S10 in FIG. 2, includes steps S111, S113 and S115. In step S111, when a computer system 5 enters swap-before-hibernate after a cold boot, the processing unit 10 stores the non-swappable memory of the main memory 12 to the storage device 14. For example, all the status values of the non-swappable memory are set to “dirty”, and the processing unit 10 performs as in step S111 when the computer system 5 enters the swap-before-hibernation. In step S113, when resuming from the swap-before-hibernate, the processing unit 10 reads the non-swappable memory from the storage device 14 and writes the non-swappable memory to the main memory 12. In step S115, an MMU 51 of the computer system 5 detects whether each of the non-swappable segments has been modified to respectively generate a status value corresponding to the non-swappable segments. For example, after step S113, all the non-swappable segments (including the core memory) partitioned from the non-swappable memory are set to “clean”. Thus, in step S115, he MMU 51 is set to marking a non-swappable segment to “dirty” once the non-swappable segment (including the segment of the core memory) has been modified.

After the initial process in step S11, step S201 is performed. In step S201, during a process of the computer system 5 entering a hibernation state, for each of the non-swappable segments, it is determined whether the non-swappable segment is to be written to the storage device 14 according to the status value of the non-swappable segment (i.e., a current value of the dirty bit). When the status value of the non-swappable segment is dirty in step S201, it is determined that the content of the non-swappable segment has been changed, and so step 203 is performed to write the non-swappable segment to the storage device 14 of the computer system 1. When the status value of the non-swappable segment is clean in step S201, it is determined that the content of the non-swappable segment has not been changed. Thus, in step S205, the computer system 5 does not write the non-swappable segment to the storage device 14 during the hibernation state.

Apart from being coupled between the processing unit 10 and the main memory 12, the MMU 51 in FIG. 5 may also be replaced by a built-in MMU of the processing unit.

### Second Embodiment

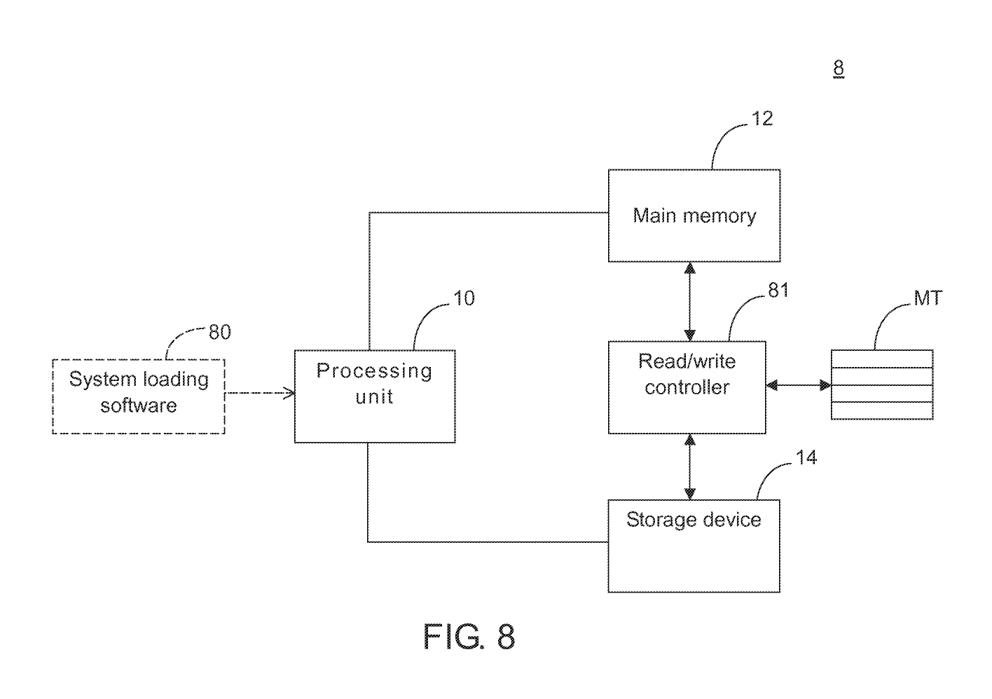

A main difference between the second embodiment and the first embodiment is that, in the second embodiment, the function of the MMU is replaced by a method executed by a processing unit or other hardware devices, and the computer system generates a corresponding status value according to the content of each of the non-swappable segments. For example, a processing unit of a computer device is utilized for calculating the status value. For another example, a computer system 8 in FIG. 8 utilizes an additional hardware device, e.g., a read/write controller 81 coupled to the main memory 12 and the storage device 14, to calculate the status value. The read/write controller 81 controls read/write processes between the main memory 12 and the storage device 14. For example, through calculations by use of a hash function, a corresponding characteristic value is generated as the above status value according to the content of each of the non-swappable segment. The characteristic value is capable of accordingly detecting whether the non-swappable segment has been modified. For example, an initial value of the characteristic value is a magic number. In the embodiment in FIG. 8, the computer system 8 includes a read/write control circuit 81 coupled between the main memory 12 and the storage device 14 to generate a corresponding status value according to the content of each of the non-swappable segments.

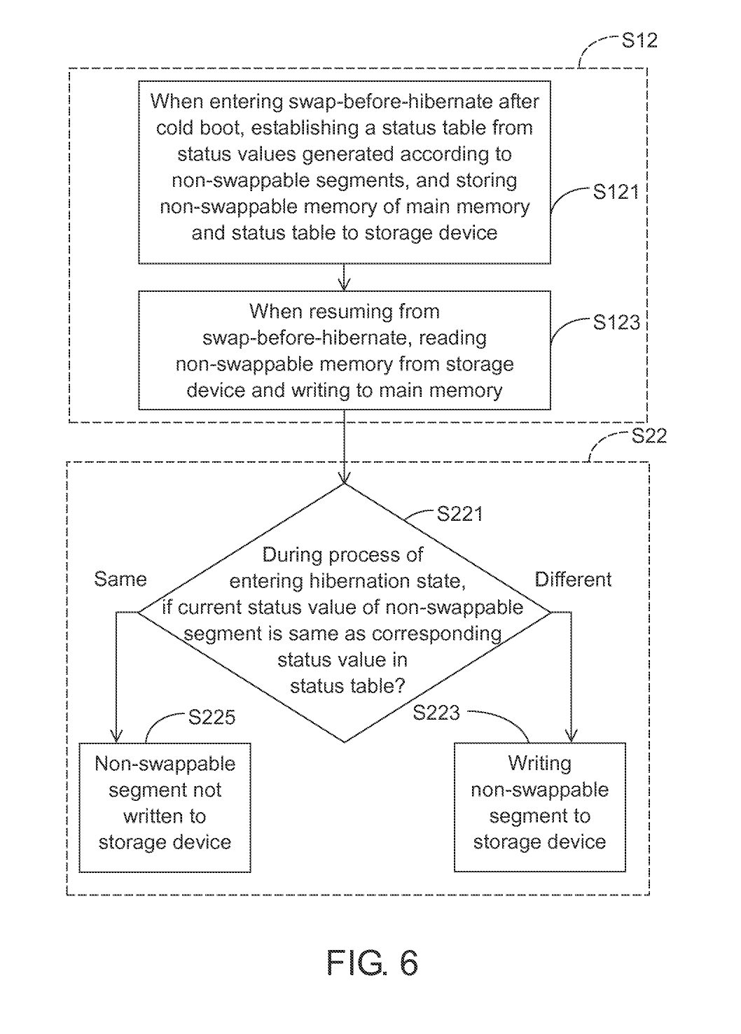

FIG. 6 shows a detailed flowchart of step S10 and step S20 in FIG. 2 according to another embodiment. FIG. 8 shows a block diagram of the embodiment in FIG. 4 applied to a computer system according to one embodiment. Referring to FIG. 6, step S12, as an initial process before step S10 in FIG. 2 in an embodiment, includes steps S121 and S123. In step S121, when a computer system (e.g., the computer system 1 or 8) enters swap-before-hibernate after a cold boot, status values corresponding to the non-swappable segments are generated to construct a status table (e.g., the status table ST in FIG. 3), and the non-swappable memory 1210 of the main memory 12 and the status table ST are stored to the storage device. In step S123, when resuming from the swap-before-hibernate, the non-swappable memory is read from the storage device 14 and written to the main memory 12.

After the initial process in step S12, step S22 is performed. Step S22 is an embodiment of step S20 in FIG. 2. In step S221, during a process of the computer system 1 or 8 entering a hibernation state, for each of the non-swappable segments, it is compared whether a current status value (e.g., a characteristic value calculated from a hash function) of the non-swappable segment is same as a corresponding status value in the status table ST, so as to determine whether the write the non-swappable segment to the storage device 14. When the current status value is different from the corresponding status value in the status table (e.g., the two values are different), it means the content of the non-swappable segment has been changed, and therefore step S223 is performed in which the processing unit writes the non-swappable segment to the storage device 14. When the comparison result in step S221 indicates being the same, it means the content of the non-swappable segment has not been changed, and step S225 is performed. In step S225, during the hibernation state, the computer system does not write the non-swappable segment to the storage device 14.

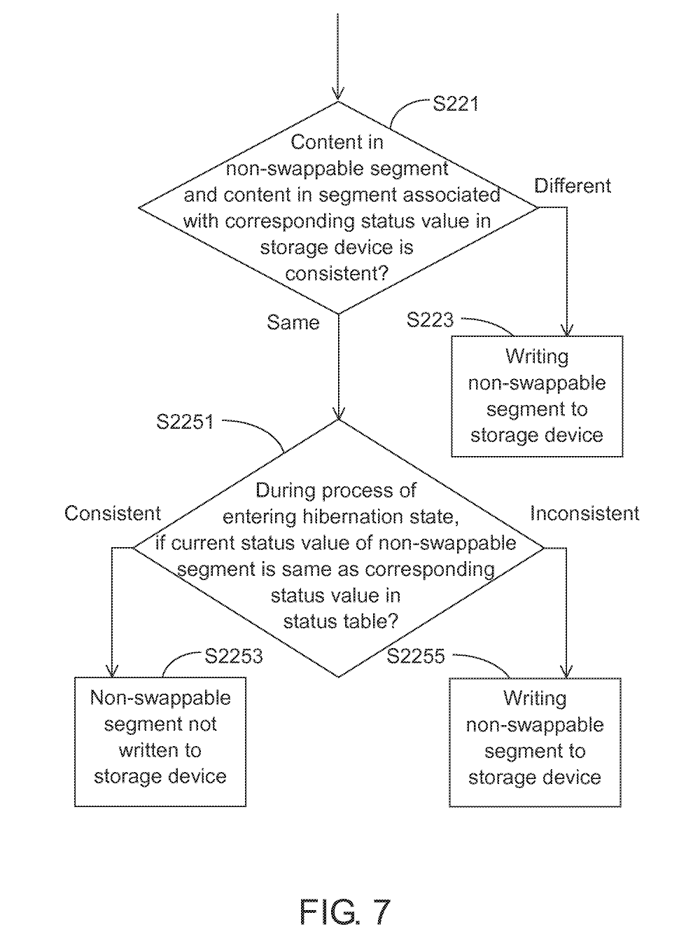

Further, when the comparison result obtained in step S221 indicates being the same, as far as a characteristic value calculated based on a hash function is concerned, it substantially indicates that data content in the non-swappable segment and in the corresponding segment of the storage device 14 is “much likely” identical. That is to say, a probability that the data content in two corresponding segments being exactly the same is very high. Under certain circumstances, e.g., under a high performance, low power consumption or another operating condition, the data contents in the two corresponding segments are regarded to be totally identical. Therefore, as shown in step S225, the non-swappable segment is not written out. Under other circumstances, e.g., under a high system operation stability or another operating condition, an additional step may be performed for confirming the data contents. For example, in another example as shown in FIG. 7, in step S2251, a computer system compares whether the content in the non-swappable segment is same as the content in the segment associated with the corresponding status value in the storage device. For example, the content is compared byte after byte, a part of the content is compared, or the content is calculated according to other approaches, so as to confirm whether the data in the non-swappable segment is entirely identical to the data in the corresponding segment in the storage device. When a comparison result in step S2251 shows the content is inconsistent, it means the content in the non-swappable segment has been changed, and so the computer system writes the non-swappable segment to the storage device 14 in step S2255. When the comparison result in step S2251 shows the content is consistent, it means the content in the non-swappable segment has not been changed, and step S2253 is performed. In step S2253, the computer system does not write the non-swappable segment to the storage device during the hibernation state.

Further, when booting the computer system (e.g., the computer system 1, 5, or 8), the first-part memory is loaded by system loading software 50 or 80 such as an operating system, BIOS or a bootloader. Since the first-part memory may be stored to a plurality of devices (e.g., the swap space 141, the file system 142 and the hibernation file 143 regarded as devices in Linux) in an intermittent manner (e.g., the segments of the non-swappable memory 1210 are stored to different corresponding memory positions in the storage device, as indicated by arrows in FIG. 3). Therefore, the system loading software 50 first reads a table (e.g., the table MT in FIG. 3), and reconstructs the first-part memory according to the content of the table MT. For example, the table MT is stored in the secondary memory, or the table is a flash translation layer (FTL).

It should be noted that, a Linux platform is taken as an example in the above description for illustrative purposes, and the embodiments may also be applied to other operating systems including BSD and Windows.

The above description discloses embodiments of the method for a hibernation mechanism and the computer system therefore. In principle, the embodiment of the method is capable of increasing the speed of fast boot for the computer system from hibernation, for resume, or for resume from hibernation.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A method for a hibernation mechanism, applicable to a computer system, comprising:
a) performing an initial process of the hibernation mechanism in the computer system, wherein a non-swappable memory of at least one main memory in the computer system is partitioned into a plurality of non-swappable segments, and each of the non-swappable segments corresponds to a status value indicating whether content of the non-swappable segment has been changed;
b) during a process of the computer system entering a hibernation state of the hibernation mechanism, for each of the non-swappable segments, determining whether the non-swappable segment is to be written to at least one storage device according to the status value of the non-swappable segment;
wherein when a determination result of the (b) indicates content of the non-swappable segment has been changed, the non-swappable segment is written to the at least one storage device of the computer system; and when the determination result indicates the content of the non-swappable segment has not been changed, the computer system does not write the non-swappable segment to the at least one storage device of the computer system in the hibernation state.

2. The method according to claim 1, wherein the (a) detects by a memory management unit (MMU) whether each of the non-swappable segments has been changed so as to accordingly record the status value corresponding to the non-swappable segment.

3. The method according to claim 1, wherein the (a) comprises:
when the computer system enters swap-before-hibernation after a cold boot, storing the non-swappable memory of the at least one main memory to the at least one storage device;
when resuming from the swap-before-hibernate, reading the non-swappable memory from the at least one storage device and writing the non-swappable memory to the at least one main memory; and
by a memory management unit (MMU) of the computer system, detecting whether each of the non-swappable segment has been changed so as to accordingly generate the status value corresponding to the non-swappable segment.

4. The method according to claim 1, wherein in the (a), the computer system, according to content of each of the non-swappable segments, generates the corresponding status value of the non-swappable segment.

5. The method according to claim 4, wherein the computer system, according to the content of each of the non-swappable segments, generates the corresponding status value of the non-swappable segment by use of a hash function.

6. The method according to claim 4, wherein the computer system, according to the content of each of the non-swappable segments, generates the corresponding status value of the non-swappable segment, and the (a) comprises:
when the computer system enters swap-before-hibernate after a cold boot, establishing a status table from the corresponding status values generated according to the non-swappable segments, and storing the non-swappable memory of the at least one main memory and the status table to the at least one storage device; and
when resuming from the swap-before-hibernation, reading the non-swappable memory from the at least one storage device and writing the non-swappable memory to the at least one main memory.

7. The method according to claim 6, wherein the (b) comprises:
for each of the non-swappable segments, comparing whether a current status value generated according to the content of the non-swappable segment is same as a corresponding status value in the status table so as to determine whether to write the non-swappable segment to the at least one storage device;
wherein if the current value is different from the corresponding status value in the status table to indicate that the content of the non-swappable segment has been changed, then the non-swappable segment is written to the at least one storage device.

8. The method according to claim 7, wherein in the (b), if the current status value is same as the corresponding status value in the status table, which indicates that the content of the non-swappable segment has not been changed, then the computer system does not write the non-swappable segment to the at least one storage device in the hibernation state.

9. The method according to claim 7, wherein in the (b), if the current status value is same as the corresponding status value in the status table, the (b) further comprises:
comparing whether the content of the non-swappable segment and the content of the segment associated with the corresponding status value in the at least one storage device is consistent; wherein if a result of the comparing indicates consistency, which indicates that the content of the non-swappable segment has not been changed, then the computer system does not write the non-swappable segment to the at least one storage device in the hibernation state.

10. The method according to claim 7, wherein in the (b):
if the current status value is same as the corresponding status value in the status table and the computer system is under a first operating condition, which indicates that the content of the non-swappable segment has not been changed, then the computer system does not write the non-swappable segment to the at least one storage device in the hibernation state; and
if the current status value is same as the corresponding status value in the status table and the computer system is under a second operating condition, it is further compared whether the content of the non-swappable segment and the content of the segment associated with the corresponding status value in the at least one storage device is consistent; when a result of the comparing indicates consistency, which indicates that the content of the non-swappable segment has not been changed, then the computer system does not write the non-swappable segment to the at least one storage device in the hibernation state.

11. A computer system, comprising:
at least one main memory;
at least one storage device; and
at least one processing unit, coupled to the at least one main memory and the at least one storage device, the at least one processing unit performing an initial process of a hibernation mechanism, a non-swappable memory of the at least one main memory being partitioned into a plurality of non-swappable segments, each of the non-swappable segments corresponding to a status value indicating whether content of the non-swappable segment has been changed;
wherein during a process of the computer system entering a hibernation state of the hibernation mechanism, for each of the non-swappable segments, it is determined whether the non-swappable segment is to be written to at least one storage device according to the status value of the non-swappable segment; when a determination result indicates content of the non-swappable segment has been changed, the at least one processing unit writes the non-swappable segment to the at least one storage device; and when the determination result indicates the content of the non-swappable segment has been not changed, the at least one processing unit does not write the non-swappable segment to the at least one storage device in the hibernation state.

12. The computer system according to claim 11, further comprising an MMU for detecting whether each of the non-swappable segments has been modified to accordingly generate the status value corresponding to the non-swappable segment.

13. The computer system according to claim 11, wherein in the initial process of the hibernation mechanism performed by the at least processing unit, when the computer system enters swap-before-hibernate after a cold boot, the at least one processing unit stores the non-swappable memory of the at least one main memory to the at least one storage device; when the computer system resumes from the swap-before-hibernate, the at least one processing unit reads the non-swappable memory from the at least one storage device and writes the non-swappable memory to the at least one main memory.

14. The computer system according to claim 11, wherein the at least one processing unit generates the corresponding status value according to the content of each of the non-swappable segments.

15. The computer system according to claim 11, further comprising:
a read/write control circuit, coupled to the at least one main memory and the at least one storage device, for generating the corresponding status value according to the content of each of the non-swappable segments.

16. The computer system according to claim 14, wherein the at least one processing unit, according to the content of each of the non-swappable segments, generates the corresponding status value of the non-swappable segment by use of a hash function.

17. The computer system according to claim 15, wherein the read/write control circuit, according to the content of each of the non-swappable segments, generates the corresponding status value of the non-swappable segment by use of a hash function.

18. The computer system according to claim 14, wherein the at least one processing unit, according to the content of each of the non-swappable segments, generates the corresponding status value of the non-swappable segment; and
in the initial process of the hibernation mechanism performed by the at least processing unit, when the computer system enters swap-before-hibernate after a cold boot, the at least one processing unit establishes a status table from the corresponding status values generated according to the non-swappable segments, and stores the non-swappable memory of the at least one main memory and the status table to the at least one storage device; and when the computer system resumes from the swap-before-hibernate, the at least one processing unit reads the non-swappable memory from the at least one storage device and writes the non-swappable memory to the at least one main memory.

19. The computer system according to claim 17, wherein after the initial process of the hibernation mechanism performed by the at least processing unit, during a process of entering a hibernation state of the hibernation mechanism, for each of the non-swappable segments, the at least one processing unit compares a current status value generated according to the content of the non-swappable segment is same as a corresponding status value in the status table to determine whether to write the non-swappable segment to the at least storage device; and when the current value is different from the corresponding status value in the status table to indicate the content of the non-swappable segment has been changed, the at least one processing unit writes the non-swappable segment to the at least one storage device.

20. The computer system according to claim 19, wherein when the current value is same as the corresponding status value in the status table to indicate the content of the non-swappable segment has not been changed, the computer system does not write the non-swappable segment to the at least one storage device in the hibernation state.

21. The computer system according to claim 19, wherein when the current value is same as the corresponding status value in the status table, the at least one processing unit further compares whether the content of the non-swappable segment and content of the segment associated with the corresponding status value in the at least one storage device is consistent; and when a result of the comparing indicates consistency to indicate the content of the non-swappable segment has not been changed, the computer system does not write the non-swappable segment to the at least one storage device in the hibernation state.
